(19) United States
(12) Patent Application Publication
(10) Pub. No.: US 2005/0189240 A1
(43) Pub. Date: Sep. 1, 2005

(54) Method and chemical sensor for determining concentrations of hydrogen peroxide and its precusor in a solution

(75) Inventors: Meng Shan Lin, Taipei County (TW); Hoang Jyh Leu, Tainan (TW)

Correspondence Address: BACON & THOMAS, PLLC, 625 SLATERS LANE, FOURTH FLOOR, ALEXANDRIA, VA, 22314, US

(73) Assignee: Tamkang University, Taipei County (TW)

(21) Appl. No.: 10/948,252

(22) Filed: Sep. 24, 2004

(30) Foreign Application Priority Data
Feb. 26, 2004 (TW) 93105012

(51) Int. Cl. G01N 27/26

(52) U.S. Cl. 205/782; 204/411

(57) ABSTRACT

A new electrochemical sensor for determining hydrogen peroxide concentration having a mixed-valence metal oxide of MₓO_{y} deposited on an electrode surface thereof is disclosed, wherein M is a transition metal and has two or more than two valences. MₓO_{y}, for example, is M₃O₄ where M is Mn, Fe, Co or Pb, Tb₄O₇ or Pr₆O₁₁. Further, this invention also discloses an electrochemical sensor for determining a concentration of a hydrogen peroxide precursor, wherein a catalyst is immobilized in the matrix or on the surface of the mixed-valence metal oxide on the electrode. In a typical biochemical system, the catalyst can be a glucose oxidase and blood glucose is catalyzed to form hydrogen peroxide, so that the concentration of blood glucose is determined.

### FIELD OF THE INVENTION

This invention is related to an electrochemical sensor for determining hydrogen peroxide concentration in a solution. Further, this invention is related to an electrochemical sensor for determining the concentration of a hydrogen peroxide precursor in a solution, which will form hydrogen peroxide under appropriate reaction conditions. In particular, this invention uses a mixed-valence metal oxide as a working electrode and a fixed potential ranging from +0.2 V to −0.3V between the working electrode and a reference electrode of 3 M KCl Ag/AgCl to catalyze the reduction of hydrogen peroxide, so that the concentration of hydrogen peroxide is measured.

### BACKGROUND OF THE INVENTION

In U.S. Pat. No. 6,042,714 one of the inventors of the present invention and his co-workers disclose a new chemical sensor to monitor H₂O₂ concentration in a liquid. The H₂O₂ chemical sensor includes a transducer which is able to conduct an electric current and a mixed-valence compound deposited on a surface of the transducer. The mixed-valence compound has a formula as follows:
M_{y}^{Z+}[Fe(II)(CN)₆]
where M can be Co, Ni, Cr, Sc, V, Cu, Mn, Ag, Eu, Cd, Zn, Ru, or Rh; z is the valence of M; and y=4/z. This prior art invention also reveals a chemical sensor to monitor a concentration of a H₂O₂ precursor. The H₂O₂ precursor is defined as a compound that can produce H₂O₂ in said liquid under appropriate reaction conditions. The H₂O₂ precursor chemical sensor contains the transducer, and a composition deposited on a surface of the transducer. The composition comprises the mixed-valence compound and a catalyst capable of catalyzing the reaction. This prior art invention uses a fixed potential ranging from +0.1 V to −0.2V between the working electrode and a reference electrode of 3 M KCl Ag/AgCl to catalyze the reduction of hydrogen peroxide, so that the concentration of hydrogen peroxide is measured. As a result, the transducer modified by the mixed-valence compound is able to monitor the H₂O₂ concentration at a potential which will not be interfered by other undesirable biochemical compounds in blood (such as ascorbic acid, uric acid, dopamine, cysteine and acetaminophen, etc.). Furthermore, by adding proper electrolyte and pH buffer the interference from oxygen (a strong reducible compound) is also prevented. The disclosure of U.S. Pat. No. 6,042,714 is incorporated herein by reference.

### SUMMARY OF THE INVENTION

The invention of the present application uses a mixed-valence metal oxide to develop chemical sensors for measuring concentrations of H₂O₂ and H₂O₂ precursor in environmental detection and medical tests.

A chemical sensor constructed according to the present invention comprises a transducer which is able to conduct an electric current and a mixed-valence metal oxide deposited on a surface of the transducer, wherein said mixed-valence metal oxide has a formula as follows:
MₓO_{y} (I)
wherein M is a transition metal and has two or more than two different valences; x and y represent moles of said transition metal, M, and oxygen, respectively, provided that 2y=(x₁)(z₁)+(x₂)(z₂) . . . +(xₙ)(zₙ), and x₁+x₂+ . . . +xₙ=x, wherein z₁, z₂, . . . zₙ represent the valences of M; x₁, x₂, . . . xₙ represent moles of M having valences of z₁, z₂, . . . zₙ, respectively, and n is a positive integer.

Preferably, M is selected from the group consisting of Ti, V, Cr, Mn, Fe, Co, Ni, Cu, Ga, Nb, Mo, Tc, Ru, Rh, Pd, Ag, In, Sn, W, Re, Ir, Pt, Au, Tl, Pb, Pr and Tb. For examples, said mixed-valence metal oxides are Mn₃O₄, Fe₃O₄, CO₃O₄ or Pb₃O₄, where M is Mn, Fe, Co or Pb, and has valences of +2 and +3; Tb₄O₇ and Pr₆O₁₁, where M is Tb or Pr, and has valences of +3 and +4.

The mixed-valence metal oxide (I) per se is very stable chemically, and not easy to be affected by humidity, temperature, and light irradiation, etc. Further, the mixed-valence metal oxide has advantages such as a good electron transfer capability, lower price, and easy availability, which make the chemical sensors of the present invention more feasible to be commercialized.

### BRIEF DESCRIPTION OF THE DRAWINGS

FIG. 1 shows a calibration curve of a working electrode upon successive injections of H₂O₂ solution to provide an increment in H₂O₂ concentration of 0.1 mM for each addition in an amperometry analysis, where the x-axis is the concentration of H₂O₂ (mM), and the y-axis is current (μA). The working electrode is a chemical sensor containing Mn₃O₄ prepared according to Example 1 of the present invention.

FIG. 2 shows a calibration curve of a working electrode upon successive injections of H₂O₂ solution to provide an increment in H₂O₂ concentration of 0.1 mM for each addition in an amperometry analysis, where the x-axis is the concentration of H₂O₂ (mM), and the y-axis is current (μA). The working electrode is a chemical sensor containing Fe₃O₄ prepared according to Example 2 of the present invention.

FIG. 3 shows a calibration curve of a working electrode upon successive injections of H₂O₂ solution to provide an increment in H₂O₂ concentration of 0.1 mM for each addition in an amperometry analysis, where the x-axis is the concentration of H₂O₂ (mM), and the y-axis is current (μA). The working electrode is a chemical sensor containing CO₃O₄ prepared according to Example 3 of the present invention.

FIG. 4a is a plot of current (μA) versus concentration of H₂O₂ (mM) upon successive injections of H₂O₂ solution to provide an increment in H₂O₂ concentration for each measurement in a chronoamperometry analysis, where the x-axis is the concentration of H₂O₂ (mM), and the y-axis is current (μA). The working electrode is a chemical sensor containing Pb₃O₄ prepared according to Example 4 of the present invention.

FIG. 4b shows the partial calibration curve of the working electrode within a H₂O₂ concentration range of 0.1 mM to 9 mM in FIG. 4a.

FIG. 5 shows a calibration curve of a working electrode upon successive injections of glucose solution to provide an increment in glucose concentration of 1 mM for each addition in an amperometry analysis, where the x-axis is the concentration of glucose (mM), and the y-axis is current (μA). The working electrode is a glucose biochemical sensor containing Fe₃O₄ prepared according to Example 5 of the present invention.

### DETAILED DESCRIPTION OF THE INVENTION

Novel chemical sensors designed to measure concentrations of H₂O₂ and H₂O₂ precursors are provided in the present invention. The novel chemical sensors comprise the mixed-valence metal oxide (I) deposited on a surface of a transducer, for example, an electrochemical electrode. The mixed-valence metal oxide provides the chemical sensors with electrode assisted catalysis in an amperometric measurement of H₂O₂ concentration in a given solution, wherein the chemical sensor is used as a working electrode.

The mixed-valence metal oxide (I) deposited on the transducer having a catalysis characteristic of reducing H₂O₂ is a metal oxide formed by two metallic nuclei connected by oxygen atom acting as a coordinating ligand. The two metallic nuclei have their own valences, and electrons within the tow metallic nuclei are in the delocalization state. As a result, the mixed-valence metal oxide can be used as an electron transferring route through the inter-valence charge transfer characteristic of the coordinating ligand. In the amperometric measurement of H₂O₂, the mixed-valence metal oxide can accomplish charge transfer and catalysis of H₂O₂, and even enhance the conductivity of the chemical sensors.

When an electrode modified with the mixed-valence metal oxide (I) is used as a working electrode in an amperometric measurement of H₂O₂, the mixed-valence metal oxide (I) is oxidized from a reduction state to an oxidation state by H₂O₂, and creates an electronic hole therein. The electronic hole is then transferred to the transducer via the inter-valence charge transfer characteristic of the mixed-valence metal oxide (I), so that a current loop is formed, and a signal in response to H₂O₂ concentration is obtained with a smaller reduction potential being applied. It is apparent that an electrode modified with this mixed-valence metal oxide (I) is also feasible for use in amperometric measurement of oxygen concentration in a given solution. But, in the measurement of hydrogen proxide, the lower applied potential can avoid the reduction of oxygen and the oxidation of easily oxidizable compounds simultaneously.

The H₂O₂ chemical sensor of the present invention has a fast response time (t_{90%}), a broad linear range of concentration vs. current, and a high sensitivity, when it is used as a working electrode in an amperometric measurement of H₂O₂ concentration in a given solution and when the reduction potential of the chemical sensor is at 0.2 to −0.3V (vs. 3 M KCl Ag/AgCl reference electrode).

When a catalyst is immobilized in the matrix or on a surface of the mixed-valence metal oxide (I) deposited on the transducer, and the catalyst can catalyze a compound in a given solution to produce H₂O₂, it is apparent that this modified transducer is able to be used to determine the compound concentration. The catalyst is called “identifier” and the compound is call “a H₂O₂ precursor” in this invention.

By blending the mixed-valence metal oxide (I) with various oxidases (such as glucose oxidase (EC 1.1.3.4), uricase (EC 1.7.3.3), cholesterol oxidase (EC 1.1.3.6), glycerophosphate oxidase (EC 1.1.3.21), sarcosine oxidase (EC 1.5.3.1), polyamine oxidase (EC 1.4.3.10)) a series of new biochemical sensors for measuring blood glucose, urea, high and low density cholesterols, triglyceride, creatinine and polyamine in blood can be prepared and applied to medical, biomedical research, including diagnostic applications. The new biochemical sensors derived from this invention have excellent specificity originated from the specificity of the oxidases. In addition, the transducer modified by the mixed-valence metal oxide is able to monitor the H₂O₂ concentration at a potential which will not be interfered by other undesirable biochemical compounds in blood (such as ascorbic acid, uric acid, dopamine, cystein and acetaminophen, etc.) and dissolved oxygen.

The mixed-valence metal oxide (I) in this invention has low solubility in water and high chemical stability, and thus it can be applied to interfacial chemistry of electrochemical analysis. The preparation of the H₂O₂ chemical sensor of the present invention is simple. For example, the mixed-valence metal oxide can mixed with an electrical conductive ink, and depositing the resulting mixture on a surface of an electrode by coating, chemical modification, sputtering or chemical vapor deposition to form a thick film electrode, which is ready for use when the ink is dry.

When the identifier is to be incorporated to the transducer together with the mixed-valence metal oxide (I) for measuring the concentration of the H₂O₂ precursor, several approaches can be taken such as polymer coating and trapping to cover the identifier under a polymer membrane, or surface adsorption and covalent bond crosslinking, thereby the identifier is immobilized to avoid the undesired variations of signals due to losing or distribution change of the identifier caused by agitation in the course of the measurement.

The invention will be further illustrated by the following examples. The following examples are only meant to illustrate the invention, but not to limit it.

### EXAMPLE 1

### Chemical Sensor Based on Mn₃O₄

(1). Pretreatment of Electrode

A rotating disk glassy carbon electrode (RDE 0032, Princeton Applied Research, 6 mm outer diameter) was polished using 3 μm and 1 μm diamond suspension, and sonicated for five minutes in deionized water. The electrode surface was then polished with 0.1 μm Al₂O₃ powder, sonicated for 5 minutes in a deionized water twice followed by rinsing with deionized water twice. Subsequently, the electrode surface was checked by a cyclic voltammetry (BAS 100W, Bioanalytical Systems) to ensure free of contamination.

(2). Preparation of a Working Electrode

A mixture having 15% of Mn₃O₄ was prepared by well mixing Mn₃O₄ and electrically conductive ink, which was then diluted with cyclohexanone to obtain a viscosity suitable for coating (the amount of cyclohexanone added was about one half of the mixture). The pretreated rotating disk glassy carbon electrode was coated with the resulting Mn₃O₄ mixture, and dried at 40° C. for 30 minutes.

(3). Measurement Conditions

The working electrode prepared above, a homemade 3M KCl Ag/AgCl reference electrode, and a platinum wire counter electrode were immersed in a 0.05 M, pH=10, glycine buffer, with 0.1 M NaCl solution to improve conductivity in an electrochemical cell. A bi-potentiostat (model PAR, 366A, Princeton Applied Research) was used to control the applied voltage at −50 mV (vs. Ag/AgCl). The detection temperature of the electrochemical cell was kept at 25° C. with a circulator (Model B402, Firstek Scientific). The glycine buffer in the cell was stirred constantly at 900 rpm with a motor controlled rotor (Model 636, Princeton Applied Research).

H₂O₂ solution was added to the glycine buffer in the cell at a constant time interval to provide an increment in H₂O₂ concentration of 0.1 mM so that steady-state amperometric measurements of hydrogen peroxide concentration were conducted.

(4). Results

After the successive injections of H₂O₂ solution to the cell, the electric current response versus time is used to establish a correlation curve of the chemical sensor prepared.

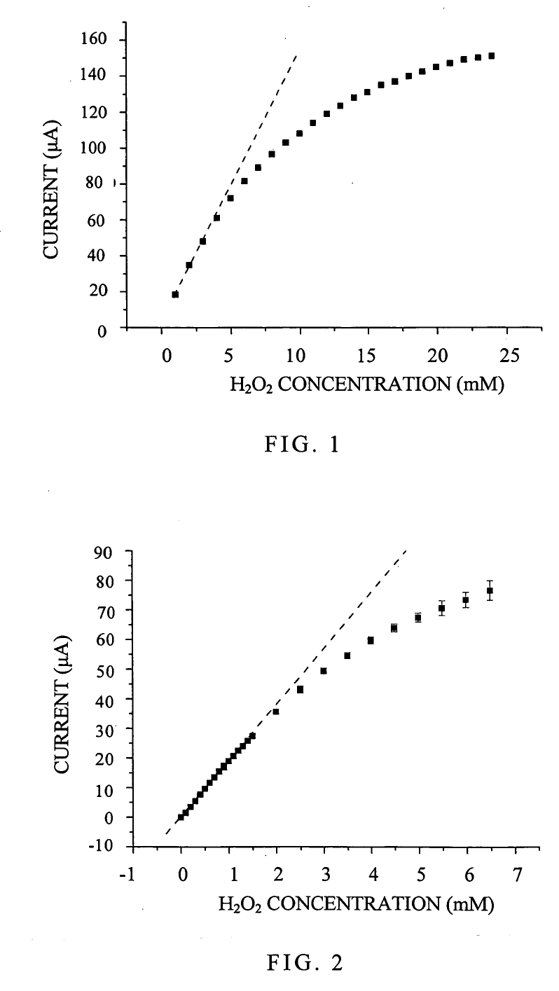

At H₂O₂ concentration of 0.1 mM, the response time that between 10% and 90% of the maximum signal (t_{90%}) was 10.2 seconds (not shown in the drawing). By plotting H₂O₂ concentration vs. current (μA), it was found that there was a linear relationship within a range from 0.1 mM to 3 mM (correlation coefficient=0.999). A slope of 2.737 μA/mM-mm² was obtained using the least square method, as shown in FIG. 1.

The measurement was repeated for 20 times using 0.1 mM H₂O₂, and a relative standard deviation of 3.5% was observed. Based on the signal-to-noise characteristics (S/N=3), it was found that the detection limit of H₂O₂ was 50 μM.

Further interference experiments indicated there was no substantial interference when measuring 0.1 mM H₂O₂ solution in the presence of 0.2 mM of ascorbic acid, uric acid, dopamine, cysteine or acetaminophen.

### EXAMPLE 2

### Chemical Sensor Based on Fe₃O₄

(1). Pretreatment of Electrode

A rotating disk graphite electrode was polished using 0.1 μm Al₂O₃ suspension, and sonicated for three minutes in deionized water. The procedures were repeated once. The electrode surface was then rinsed with deionized water twice. Finally, the electrode surface was checked by a cyclic voltammetry (BAS 100W, Bioanalytical Systems) to ensure free of contamination.

(2). Preparation of a Working Electrode

A mixture having 50% of Fe₃O₄ was prepared by well mixing Fe₃O₄ and electrically conductive ink, which was then diluted with cyclohexanone to obtain a viscosity suitable for coating (the amount of cyclohexanone added was four times of the mixture). The pretreated rotating disk graphite electrode was coated with the resulting Fe₃O₄ mixture, and dried at room temperature (25° C.) for 30 minutes.

(3). Measurement Conditions

The working electrode prepared above, a homemade 3M KCl Ag/AgCl reference electrode, and a platinum wire counter electrode were immersed in a 0.05 M, pH=3, citrate buffer, with 0.1 M KCl solution to improve conductivity in an electrochemical cell. A bi-potentiostat (model PAR, 366A, Princeton Applied Research) was used to control the applied voltage at −200 mV (vs. Ag/AgCl). The detection temperature of the electrochemical cell was kept at 25° C. with a circulator (Model B402, Firstek Scientific). The citrate buffer in the cell was stirred constantly at 900 rpm with a motor controlled rotor (Model 636, Princeton Applied Research).

H₂O₂ solution was added to the citrate buffer in the cell at a constant time interval to provide an increment in H₂O₂ concentration of 0.1 mM so that steady-state amperometric measurements of hydrogen peroxide concentration were conducted.

(4). Results

After the successive injections of H₂O₂ solution to the cell, the electric current response versus time is used to establish a correlation curve of the chemical sensor prepared.

At H₂O₂ concentration of 0.1 mM, the response time that between 10% and 90% of the maximum signal (t_{90%}) was 5.2 seconds (not shown in the drawing). By plotting H₂O₂ concentration vs. current (μA), it was found that there was a linear relationship within a range from 0.05 mM to 1.5 mM (correlation coefficient=0.9993). A slope of 0.89 μA/mM-mm² was obtained using the least square method, as shown in FIG. 2.

The measurement was repeated for 20 times using 0.1 mM H₂O₂, and a relative standard deviation of 2.18% was observed. Based on the signal-to-noise characteristics (S/N=3), it was found that the detection limit of H₂O₂ was 81 μM.

Further interference experiments indicated there was no substantial interference when measuring 0.1 mM H₂O₂ solution in the presence of 0.2 mM of ascorbic acid, uric acid, dopamine, cysteine or acetaminophen.

### EXAMPLE 3

### Chemical Sensor Based on CO₃O₄

(1). Pretreatment of Electrode

A rotating disk graphite electrode was polished using 0.1 μm Al₂O₃ suspension, and sonicated for three minutes in deionized water. The procedures were repeated once. The electrode surface was then rinsed with deionized water twice. Finally, the electrode surface was checked by a cyclic voltammetry (BAS 100W, Bioanalytical Systems) to ensure free of contamination.

(2). Preparation of a Working Electrode

A mixture having 10% of CO₃O₄ was prepared by well mixing CO₃O₄ and electrically conductive ink, which was then diluted with cyclohexanone to obtain a viscosity suitable for coating (the amount of cyclohexanone added was the same as the mixture). The pretreated rotating disk graphite electrode was coated with the resulting CO₃O₄ mixture, and dried at room temperature (25° C.) for 30 minutes.

(3). Measurement Conditions

The working electrode prepared above, a homemade 3M KCl Ag/AgCl reference electrode, and a platinum wire counter electrode were immersed in a 0.05 M, pH=9, tris-(hydroxymethyl)aminomethane buffer, with 0.1 M NaCl solution to improve conductivity in an electrochemical cell. A bi-potentiostat (model PAR, 366A, Princeton Applied Research) was used to control the applied voltage at −150 mV (vs. Ag/AgCl). The detection temperature of the electrochemical cell was kept at 25° C. with a circulator (Model B402, Firstek Scientific). The tris-(hydroxymethyl)aminomethane buffer in the cell was stirred constantly at 625 rpm with a motor controlled rotor (Model 636, Princeton Applied Research).

H₂O₂ solution was added to the tris-(hydroxymethyl)aminomethane buffer in the cell at a constant time interval to provide an increment in H₂O₂ concentration of 0.1 mM so that steady-state amperometric measurements of hydrogen peroxide concentration were conducted.

(4). Results

After the successive injections of H₂O₂ solution to the cell, the electric current response versus time is used to establish a correlation curve of the chemical sensor prepared.

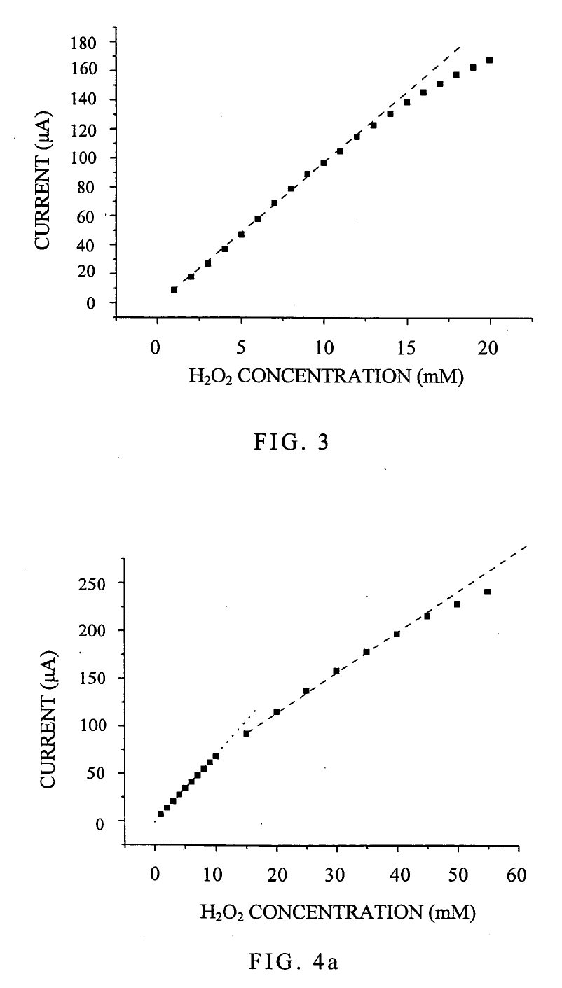

At H₂O₂ concentration of 0.1 mM, the response time that between 10% and 90% of the maximum signal (t_{90%}) was 12.3 seconds (not shown in the drawing). By plotting H₂O₂ concentration vs. current (μA), it was found that there was a linear relationship within a range from 0.1 mM to 14 mM (correlation coefficient=0.999). A slope of 0488 μA/mM-mm² was obtained using the least square method, as shown in FIG. 3.

The measurement was repeated for 20 times using 0.1 mM H₂O₂, and a relative standard deviation of 3.5% was observed. Based on the signal-to-noise characteristics (S/N=3), it was found that the detection limit of H₂O₂ was 3.3 μM.

Further interference experiments indicated there was no substantial interference when measuring 0.1 mM H₂O₂ solution in the presence of 0.2 mM of ascorbic acid, uric acid, dopamine, cysteine or acetaminophen.

### EXAMPLE 4

### Chemical Sensor Based on Pb₃O₄

(1). Pretreatment of Electrode

A rotating disk glassy carbon electrode (RDE 0032, Princeton Applied Research, 6 mm outer diameter) was polished using 3 μm and 1 μm diamond suspension, and sonicated for five minutes in deionized water. The electrode surface was then polished with 0.1 μm Al₂O₃ powder, sonicated for 5 minutes in a deionized water twice followed by rinsing with deionized water twice. Subsequently, the electrode surface was checked by a cyclic voltammetry (BAS 100W, Bioanalytical Systems) to ensure free of contamination.

(2). Preparation of a Working Electrode

A mixture having 50% of Pb₃O₄ was prepared by well mixing Pb₃O₄ and electrically conductive ink, which was then diluted with cyclohexanone to obtain a viscosity suitable for coating (the amount of cyclohexanone added was about the same as the mixture). The pretreated rotating disk glassy carbon electrode was coated with the resulting Pb₃O₄ mixture, and dried at 40° C. for 30 minutes.

(3). Measurement Conditions

The working electrode prepared above, a homemade 3M KCl Ag/AgCl reference electrode, and a platinum wire counter electrode were immersed in a 0.2 M, pH=6, acetate buffer in an electrochemical cell. Chronoamperometry was conducted to measure H₂O₂ concentrations, wherein a working voltage at −200 mV (vs. Ag/AgCl) jumped from an initial voltage of 500 mV was used, and the sampling time was three seconds. The detection temperature of the electrochemical cell was kept at 25° C. with a circulator (Model B402, Firstek Scientific). The acetate buffer in the cell was stirred homogenously.

H₂O₂ solution was added to the acetate buffer in the cell at a constant time interval to provide an increment in H₂O₂ concentration of 0.1 mM so that stable amperometric measurements of hydrogen peroxide concentration were conducted.

(4). Results

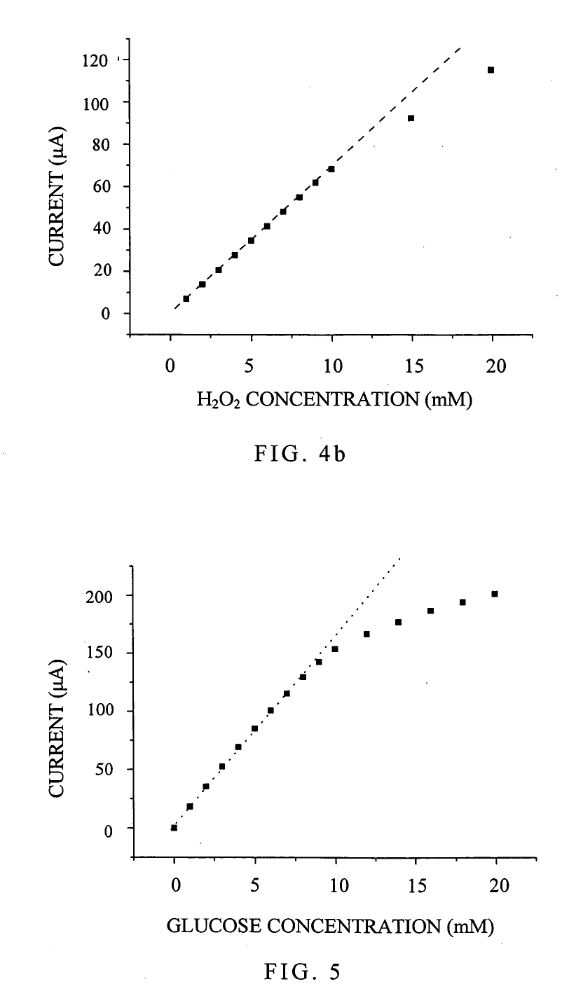

After the successive injections of H₂O₂ solution to the cell, the electric current response versus H₂O₂ concentration was plotted. Two linear sectors were observed, which ranges from 0.1 mM to 9 mM and form 9 mM to 46 mM with correlation coefficients of 0.9995 and 0.9997, respectively, as shown FIG. 4a. A slope of 0.11 μA/mM-mm² was obtained in the sector of 0.1 mM to 9 mM using the least square method, as shown in FIG. 4b.

The measurement was repeated for 20 times using 0.1 mM H₂O₂, and a relative standard deviation of 4.657% was observed. Based on the signal-to-noise characteristics (S/N=3), it was found that the detection limit of H₂O₂ was 20 nM.

Further interference experiments indicated there was no substantial interference when measuring 0.1 mM H₂O₂ solution in the presence of 0.2 mM of ascorbic acid, uric acid, dopamine, cysteine or acetaminophen.

### EXAMPLE 5

### Glucose Biochemical Sensor Based on Fe₃O₄

(1). Pretreatment of Electrode

A rotating disk graphite electrode was polished using 0.1 μm Al₂O₃ suspension, and sonicated for three minutes in deionized water. The procedures were repeated once. The electrode surface was then rinsed with deionized water twice. Finally, the electrode surface was checked by a cyclic voltammetry (BAS 100W, Bioanalytical Systems) to ensure free of contamination.

(2). Preparation of a Working Electrode

A mixture having 50% of Fe₃O₄ was prepared by well mixing Fe₃O₄ and electrically conductive ink, which was then diluted with cyclohexanone to obtain a viscosity suitable for coating (the amount of cyclohexanone added was four times of the mixture). The pretreated rotating disk graphite electrode was coated with the resulting Fe₃O₄ mixture, and dried at room temperature (25° C.) for 30 minutes. An aqueous solution containing glucose oxidase and cross-linking reagent was added to the surface of the resulting electrode drop by drop until reached 5 units of addition of glucose oxidase, dried at room temperature, and an ethanol solution of Nafion® was dropped on the dried surface of the electrode and dried to immobilize the glucose oxidase.

(3). Measurement Conditions

The working electrode prepared above, a homemade 3M KCl Ag/AgCl reference electrode, and a platinum wire counter electrode were immersed in a 0.05 M, pH=7, phosphate buffer, with 0.1 M NaCl solution to improve conductivity in an electrochemical cell. A bi-potentiostat (model PAR, 366A, Princeton Applied Research) was used to control the applied voltage at −200 mV (vs. Ag/AgCl). The detection temperature of the electrochemical cell was kept at 25° C. with a circulator (Model B402, Firstek Scientific). The phosphate buffer in the cell was stirred constantly at 900 rpm with a motor controlled rotor (Model 636, Princeton Applied Research).

Glucose solution was added to the phosphate buffer in the cell at a constant time interval to provide an increment in glucose concentration of 1 mM so that steady-state amperometric measurements of glucose concentration were conducted.

(4). Results

After the successive injections of glucose solution to the cell, the electric current response versus time is used to establish a correlation curve of the biochemical sensor prepared.

At glucose concentration of 1 mM, the response time that between 10% and 90% of the maximum signal (t_{90%}) was 8.4 seconds (not shown in the drawing). By plotting glucose concentration vs. current (μA), it was found that there was a linear relationship within a range from 1 mM to 8 mM (correlation coefficient=0.999). A slope of 0.89 μA/mM-mm² was obtained using the least square method, as shown in FIG. 5.

The measurement was repeated for 20 times using 1 mM glucose, and a relative standard deviation of 2.18% was observed. Based on the signal-to-noise characteristics (S/N=3), it was found that the detection limit of glucose was 81 μM.

Further interference experiments indicated there was no substantial interference when measuring 1 mM glucose solution in the presence of 0.2 mM of ascorbic acid, uric acid, dopamine, cysteine or acetaminophen.

In the Examples, the working electrodes (6 mm diameter) are relatively small in size in comparison with the volume of the buffer solutions in the cell, so that a steady-state amperometric measurement is possible only when the buffer solutions are in a homogenous phase under sufficient stirring. However, a minute working electrode can be prepared by screen printing a small amount of the mixed-valence metal oxide/electrical conductive ink mixture on an insulation plate. In this case, a small amount of solution which is able to cover the minute working electrode, the reference electrode and the counter electrode, and an instant current detected are sufficient to determine the H₂O₂ concentration or the H₂O₂ precursor concentration. When the volume of the solution is very small such that no substantial potential drop caused by the solution, the reference electrode can be omitted. Therefore, this invention also discloses a technique of preparing a minute chemical sensor and determining H₂O₂ concentration including the following steps:
a) forming a working electrode, a reference electrode and a counter electrode on an insulation plate by screen printing, wherein the working electrode contains the mixed-valence metal oxide, and electrical conductive ink, the reference electrode contains a Ag/AgCl ink, and the counter electrode contains an electrical conductive ink;
b) contacting an unknown solution with the working electrode, the reference electrode and the counter electrode on the plate at the same time;
c) conducting a chronoamperometric measurement so that an instant current is detected from the H₂O₂ chemical sensor; and
d) determining H₂O₂ concentration of the unknown solution by comparing a magnitude of the instant current obtained from step c) with a H₂O₂ calibration curve previously established from known H₂O₂ concentration solutions by the chronoamperometric measurement under same conditions.

This invention further discloses a new technique of preparing a minute biochemical sensor and of determining H₂O₂ precursor concentration including the following steps:
a) forming a working electrode, a reference electrode, a counter electrode and an identifier on an insulation plate by screen printing, wherein the working electrode contains the mixed-valence metal oxide and electrical conductive ink, the reference electrode contains a Ag/AgCl ink, the counter electrode contains an electrical conductive ink, and the identifier contains an enzyme, usually an oxidase;
b) contacting an unknown solution with the working electrode, the reference electrode, the counter electrode and the identified on the plate at the same time, wherein H₂O₂ will be generated from the reaction of the H₂O₂ precursor and the identified;
c) conducting a chronoamperometric measurement so that an instant current is detected from the biochemical sensor; and
d) determining H₂O₂ precursor concentration of the unknown solution by comparing a magnitude of the instant current obtained from step c) with a H₂O₂ precursor calibration curve previously established from solutions of known H₂O₂ precursor concentrations by the chronoamperometric measurement under same conditions.

Although particular embodiments of the invention have been described, various alternations, modifications, and improvements will readily occur to those skilled in the art. Accordingly, the forgoing description is by way of example only and is not intended as limiting. This invention is limited only as defined in the following claims and the equivalents thereto.

1. A chemical sensor comprising a transducer which is able to conduct an electric current and a mixed-valence metal oxide deposited on a surface of the transducer, wherein said mixed-valence metal oxide has a formula as follows:
MₓO_{y}
wherein M is a transition metal and has two or more than two different valences; x and y represent moles of said transition metal, M, and oxygen, respectively, provided that 2y=(x₁)(z₁)+(x₂)(z₂) . . . +(xₙ)(zₙ), and x₁+x₂+ . . . +xₙ=x, wherein z₁, z₂, . . . zₙ represent the valences of M; x₁, x₂, . . . xₙ represent moles of M having valences of z₁, z₂, . . . zₙ, respectively, and n is a positive integer.

2. The chemical sensor according to claim 1, wherein M is selected from the group consisting of Ti, V, Cr, Mn, Fe, Co, Ni, Cu, Ga, Nb, Mo, Tc, Ru, Rh, Pd, Ag, In, Sn, W, Re, Ir, Pt, Au, Tl, Pb, Pr and Tb.

3. The chemical sensor according to claim 2, wherein said formula of said mixed-valence metal oxide is M₃O₄, and M is Mn and has valences of +2 and +3.

4. The chemical sensor according to claim 2, wherein said formula of said mixed-valence metal oxide is M₃O₄, and M is Fe and has valences of +2 and +3.

5. The chemical sensor according to claim 2, wherein said formula of said mixed-valence metal oxide is M₃O₄, and M is Co and has valences of +2 and +3.

6. The chemical sensor according to claim 2, wherein said formula of said mixed-valence metal oxide is M₃O₄, and M is Pb and has valences of +2 and +3.

7. The chemical sensor according to claim 2, wherein said formula of said mixed-valence metal oxide is M₄O₇, and M is Tb and has valences of +3 and +4.

8. The chemical sensor according to claim 2, wherein said formula of said mixed-valence metal oxide is M₆O₁₁, and M is Pr and has valences of +3 and +4.

9. The chemical sensor according to claim 1 further comprising a catalyst deposited on the surface of the transducer, wherein said catalyst is able to catalyze a H₂O₂ precursor to undergo a reaction producing H₂O₂.

10. The chemical sensor according to claim 9, wherein said catalyst is glucose oxidase.

11. The chemical sensor according to claim 9, wherein said catalyst is uricase.

12. The chemical sensor according to claim 9, wherein said catalyst is cholesterol oxidase.

13. The chemical sensor according to claim 9, wherein said catalyst is glycerophosphate oxidase.

14. The chemical sensor according to claim 9, wherein said catalyst is sarcosine oxidase.

15. The chemical sensor according to claim 9, wherein said catalyst is polyamine oxidase.

16. A method for measuring H₂O₂ concentration in a solution comprising the following steps:
a) contacting a counter electrode, a reference electrode and a working electrode with a solution, wherein said working electrode comprises a transducer which is able to conduct an electric current and a mixed-valence metal oxide deposited on a surface of the transducer, wherein said mixed-valence metal oxide has a formula as follows:
MₓO_{y}
wherein M is a transition metal and has two or more than two different valences; x and y represent moles of said transition metal, M, and oxygen, respectively, provided that 2y=(x₁)(z₁)+(x₂)(z₂) . . . +(xₙ)(zₙ), and x₁+x₂+ . . . +xₙ=x, wherein z₁, z₂, . . . zₙ represent the valences of M; x₁, x₂, . . . xₙ represent moles of M having valences of z₁, z₂, . . . zₙ, respectively, and n is a positive integer;
b) obtaining an electric current from the working electrode by apmerometry, wherein a fixed potential between the working electrode and the reference electrode is maintained, and said fixed potential ranges from +0.2 V to −0.3V when the reference electrode is 3 M KCl Ag/AgCl electrode; and
c) comparing the electric current from b) with electric currents obtained from solutions having known H₂O₂ concentrations under substantially the same operating conditions and the same fixed potential used in steps a) and b), so that a concentration of H₂O₂ in said solution is calculated from said comparison.

17. The method according to claim 16, wherein M is selected from the group consisting of Ti, V, Cr, Mn, Fe, Co, Ni, Cu, Ga, Nb, Mo, Tc, Ru, Rh, Pd, Ag, In, Sn, W, Re, Ir, Pt, Au, Tl, Pb, Pr and Tb.

18. The method according to claim 17, wherein said formula of said mixed-valence metal oxide is M₃O₄, and M is Mn and has valences of +2 and +3.

19. The method according to claim 17, wherein said formula of said mixed-valence metal oxide is M₃O₄, and M is Fe and has valences of +2 and +3.

20. The method according to claim 17, wherein said formula of said mixed-valence metal oxide is M₃O₄, and M is Co and has valences of +2 and +3.

21. The method according to claim 17, wherein said formula of said mixed-valence metal oxide is M₃O₄, and M is Pb and has valences of +2 and +3.

22. The method according to claim 17, wherein said formula of said mixed-valence metal oxide is M₄O₇, and M is Tb and has valences of +3 and +4.

23. The method according to claim 17, wherein said formula of said mixed-valence metal oxide is M₆O₁₁, and M is Pr and has valences of +3 and +4.

24. The method according to claim 16, wherein step a) further comprises maintaining the solution in a homogeneous phase by stirring, and maintaining a substantially constant pH by adding a pH-buffer, and adding an electrolyte to the solution.

25. The method according to claim 24, wherein said pH-buffer is citrate buffer, glycine buffer, tris-(hydroxymethyl)aminomethane buffer or acetate buffer, and said electrolyte is an alkali metal halide.

26. The method according to claim 24, wherein said formula of said mixed-valence metal oxide is M₃O₄, and M is Mn and has valences of +2 and +3, wherein said pH-buffer is glycine buffer, said electrolyte is NaCl, and said fixed potential is −50 mV.

27. The method according to claim 24, wherein said formula of said mixed-valence metal oxide is M₃O₄, and M is Fe and has valences of +2 and +3, wherein said pH-buffer is citrate buffer, said electrolyte is NaCl, and said fixed potential is −200 mV.

28. The method according to claim 24, wherein said formula of said mixed-valence metal oxide is M₃O₄, and M is Co and has valences of +2 and +3, wherein said pH-buffer is tris-(hydroxymethyl)aminomethane buffer, said electrolyte is NaCl, and said fixed potential is −150 mV.

29. The method according to claim 24, wherein said formula of said mixed-valence metal oxide is M₃O₄, and M is Pb and has valences of +2 and +3, wherein said pH-buffer is acetate buffer, said electrolyte is NaCl, and said fixed potential is −200 mV.

30. The method according to claim 16, wherein said electric current is a steady electric current.

31. The method according to claim 16, wherein said electric current is an instant electric current.

32. A method for measuring a concentration of a hydrogen peroxide precursor in a solution comprising the following steps:
a) contacting a counter electrode, a reference electrode and a working electrode with a solution, wherein said working electrode comprises a transducer which is able to conduct an electric current, a catalyst deposited on a surface of the transducer, said catalyst being able to catalyze a H₂O₂ precursor to undergo a reaction producing H₂O₂, and a mixed-valence metal oxide deposited on the surface of the transducer, wherein said mixed-valence metal oxide has a formula as follows:
MₓO_{y}
wherein M is a transition metal and has two or more than two different valences; x and y represent moles of said transition metal, M, and oxygen, respectively, provided that 2y=(x₁)(z₁)+(x₂)(z₂) . . . +(xₙ)(zₙ), and x₁+x₂+ . . . +xₙ=x, wherein z₁, z₂, . . . zₙ represent the valences of M; x₁, x₂, . . . xₙ represent moles of M having valences of z₁, z₂, . . . zₙ, respectively, and n is a positive integer;
b) obtaining an electric current from the working electrode by apmerometry, wherein a fixed potential between the working electrode and the reference electrode is maintained, and said fixed potential ranges from +0.2 V to −0.3V when the reference electrode is 3 M KCl Ag/AgCl electrode; and
c) comparing the electric current from b) with electric currents obtained from solutions having known concentrations of said H₂O₂ precursor under substantially the same operating conditions and the same fixed potential used in steps a) and b), so that a concentration of H₂O₂ precursor in said solution is calculated from said comparison.

33. The method according to claim 32, wherein M is selected from the group consisting of Ti, V, Cr, Mn, Fe, Co, Ni, Cu, Ga, Nb, Mo, Tc, Ru, Rh, Pd, Ag, In, Sn, W, Re, Ir, Pt, Au, Tl, Pb, Pr and Tb.

34. The method according to claim 33, wherein said formula of said mixed-valence metal oxide is M₃O₄, and M is Mn and has valences of +2 and +3.

35. The method according to claim 33, wherein said formula of said mixed-valence metal oxide is M₃O₄, and M is Fe and has valences of +2 and +3.

36. The method according to claim 33, wherein said formula of said mixed-valence metal oxide is M₃O₄, and M is Co and has valences of +2 and +3.

37. The method according to claim 33, wherein said formula of said mixed-valence metal oxide is M₃O₄, and M is Pb and has valences of +2 and +3.

38. The method according to claim 33, wherein said formula of said mixed-valence metal oxide is M₄O₇, and M is Tb and has valences of +3 and +4.

39. The method according to claim 33, wherein said formula of said mixed-valence metal oxide is M₆O₁₁, and M is Pr and has valences of +3 and +4.

40. The method according to claim 32, wherein step a) further comprises maintaining the solution in a homogeneous phase by stirring, and maintaining a substantially constant pH by adding a pH-buffer, and adding an electrolyte to the solution.

41. The method according to claim 40, wherein said pH-buffer is citrate buffer, glycine buffer, tris-(hydroxymethyl)aminomethane buffer or acetate buffer, and said electrolyte is an alkali metal halide.

42. The method according to claim 40, wherein said formula of said mixed-valence metal oxide is M₃O₄, and M is Mn and has valences of +2 and +3, wherein said pH-buffer is glycine buffer, said electrolyte is NaCl, and said fixed potential is −50 mV.

43. The method according to claim 40, wherein said formula of said mixed-valence metal oxide is M₃O₄, and M is Fe and has valences of +2 and +3, wherein said pH-buffer is citrate buffer, said electrolyte is NaCl, and said fixed potential is −200 mV.

44. The method according to claim 40, wherein said formula of said mixed-valence metal oxide is M₃O₄, and M is Co and has valences of +2 and +3, wherein said pH-buffer is tris-(hydroxymethyl)aminomethane buffer, said electrolyte is NaCl, and said fixed potential is −150 mV.

45. The method according to claim 40, wherein said formula of said mixed-valence metal oxide is M₃O₄, and M is Pb and has valences of +2 and +3, wherein said pH-buffer is acetate buffer, said electrolyte is NaCl, and said fixed potential is −200 mV.

46. The method according to claim 32, wherein said catalyst is glucose oxidase, and said H₂O₂ precursor is glucose.

47. The method according to claim 32, wherein said catalyst is uricase, and said H₂O₂ precursor is urea.

48. The method according to claim 32, wherein said catalyst is cholesterol oxidase, and said H₂O₂ precursor is cholesterol.

49. The method according to claim 32, wherein said catalyst is glycerophosphate oxidase, and said H₂O₂ precursor is triglyceride.

50. The method according to claim 32, wherein said catalyst is sarcosine oxidase, and said H₂O₂ precursor is creatinine.

51. The method according to claim 32, wherein said catalyst is polyamine oxidase, and said H₂O₂ precursor is polyamine.

52. The method according to claim 32, wherein said electric current is a steady electric current.

53. The method according to claim 32, wherein said electric current is an instant electric current.
